(19) United States
(12) Patent Application Publication
(10) Pub. No.: US 2015/0355353 A1
(43) Pub. Date: Dec. 10, 2015

(54) DETECTING SUBSURFACE STRUCTURES

(71) Applicants: Matthew S. CASEY, (US); Antonio, R., Dacosta PAIVA, (US); Martin J. TERRELL, (US); Heather G. LUCKOW, (US); Suyash P. AWATE, (US); Ross T. WHITAKER, (US); Peihong ZHU, (US)

(72) Inventors: Ross T. Whitaker, Salt Lake City, UT (US); Peihong Zhu, Annandale, NJ (US); Matthew S. Casey, Houston, TX (US); Antonio R.C. Paiva, Spring, TX (US); Heather G. Luckow, Houston, TX (US); Martin J. Terrell, Spring, TX (US); Suyash P. Awate, Salt Lake City, UT (US)

(21) Appl. No.: 14/763,142

(22) PCT Filed: Dec. 31, 2013
(86) PCT No.: PCT/US13/78407

§ 371 Date: Jul. 23, 2015

Related U.S. Application Data
(60) Provisional application No. 61/764,811, filed on Feb. 14, 2013.

(51) Int. Cl. G01V 1/28; G01V 99/00

(52) U.S. Cl. CPC G01V 1/28; G01V 99/005; G01V 1/40

(57) ABSTRACT

Systems and methods for analyzing geophysical data to identify structures in a subsurface are provided herein. In an exemplary method, an iterative optimization is performed that includes computing similarities between potential shapes and shape cluster models, updating cluster memberships and the shape cluster models, and determining if a criterion is improved from a previous iteration.

### CROSS-REFERENCE TO RELATED APPLICATION

This application claims the benefit of U.S. Provisional Patent Application 61/764,811, filed Feb. 14, 2013 entitled DETECTING SUBSURFACE STRUCTURES, the entirety of which is incorporated by reference herein.

### FIELD

The present techniques are directed to a system and methods for analyzing subsurface data. More specifically, the present techniques are directed to a system and methods for clustering data to detect structures in the subsurface.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

To search for hydrocarbon accumulations in the earth, geoscientists often use methods of remote sensing to obtain information below the earth's surface. In the routinely used seismic reflection method, man-made sound waves are generated near the surface. The sound propagates into the earth, and as the sound passes from one rock layer into another, a small portion of the sound reflects back to the surface, where it is recorded as seismic data. Typically, hundreds to thousands of recording instruments are employed. Sound waves are sequentially excited at many different surface locations, and the recording instruments record the sound waves as seismic data. A two-dimensional or three-dimensional image of the subsurface is obtained from data processing of the recorded seismic data. Other types of remote sensing may also be used to generate data about the subsurface, such as electromagnetic data, gravitational data, core samples, well logs, and the like.

Seismic interpretation generally involves a person skilled in geologic interpretation, referred to as an interpreter, who reviews seismic reflections and maps the seismic reflections into seismic horizons. A seismic horizon may include boundaries in the subsurface structures that are useful to an interpreter, which is a subjective process. Further, manually identifying seismic horizons using an interpreter may be a time consuming process.

Typically, the interpreter is initially tasked with examining the data to identify regions in the subsurface with the potential of containing hydrocarbon accumulations. These regions are then carefully examined to develop a list of prospects, or areas in which hydrocarbons are predicted to exist in economic quantities. As used herein, the term “prospect” refers to a geologic or geophysical anomalous feature that is recommended for drilling a well based on direct hydrocarbon indications or a reasonable probability of encountering reservoir-quality rocks, a trap of sufficient size, adequate sealing rocks, and appropriate conditions for generation and migration of hydrocarbons to fill the trap. Current techniques for seismic data analysis, however, are often tedious, labor-intensive, and time-consuming.

Tool sets for computer-aided volume interpretation typically include horizon tracking techniques that are used to find seismic horizons. For example, horizon tracking may follow the peaks of seismic amplitudes starting with a user provided seed point in a vertical seismic section. The vertical seismic section can be either a cross-line vertical section in the y-z plane or an in-line vertical section in the x-z plane. An example of a horizon tracking technique is discussed in U.S. Patent Application Publication No. 2008/0285384 by James. The application describes a seed picking algorithm that can use a first point for picking a set of second points from a data set. Each of the points in the set of second points can be set as the first point, and the algorithm may repeat.

In another example, International Patent Application Publication No. 2010/047856, by Mark Dobin et al., describes a method and system that may identify a geologic object through cross sections of a geologic data volume. The method includes obtaining a geologic data volume having a set of cross sections. Then, two or more cross sections can be selected, and a transformation vector can be estimated between the cross sections. Based on the transformation vector, a geologic object can be identified within the geologic data volume. Accordingly, the techniques may be used to find geologic objects, such as horizons, using input from an interpreter. However, such techniques are typically labor intensive and time consuming due to the dependency on such input from the interpreter. Therefore, such techniques may not be cost-effective for very large seismic data sets.

U.S. Patent Application Publication No. 2011/0272161, by Kumaran et al., discloses a windowed statistical analysis for anomaly detection in geophysical datasets. This application describes a method for identifying geologic features from geophysical or attribute data that can use windowed principal component, independent component, or diffusion mapping analysis. It claims to identify subtle features in partial or residual data volumes. The residual data volumes are created by eliminating data not captured by the most prominent principal components. The partial data volumes are created by projecting the data on to selected principal components. Geologic features may also be identified from pattern analysis or anomaly volumes generated with a variable-scale data similarity matrix. The method is suitable for identifying physical features indicative of hydrocarbon potential. Although the techniques may cluster anomalous pixels, it does not determine whether anomolous data features comprise a single object.

Automation of the detection of features has been performed in image analysis. The techniques have often been based on detecting sets of spatially related pixels based on spatial co-occurrences. For example, U.S. Pat. No. 8,131,086, to Xian-Sheng et al., discloses a kernelized spatial-contextual image classification technique. For example, a first spatial-contextual model can be generated to represent a first image, the first spatial-contextual model having a plurality of interconnected nodes arranged in a first pattern of connections with each node connected to at least one other node. A second spatial-contextual model can be generated to represent a second image using the first pattern of connections. The distance between corresponding nodes in the first spatial-contextual model and the second spatial-contextual model can be estimated based on a relationship with adjacent connected nodes to determine a distance between the first image and the second image.

As another example, U.S. Patent Application Publication No. 2010/0191722, by Boiman et al., provides a technique for comparing media files based on local and global evidence scores. The method includes finding regions of a reference signal which provide local evidence scores or a global evidence score. The local evidence scores indicate local similarity of the regions of the reference signal to regions of a query signal and the global evidence score defines the extent of a global similarity of the query signal to the reference signal. The techniques utilize a media exploring device, which includes an importance encoder and a media explorer. The importance encoder generates importance scores of at least portions of digital media as a function of the local evidence scores or global evidence scores. The media explorer enables exploring through the digital media according to the importance scores and data associations or links induced by the evidence scores between different portions of the digital media. A labeling or annotation module inherits labels, annotations, or markings according to the data associations.

Other studies that explore co-occurrences are described in M. Partio, B. Cramariuc, and M. Gabbouj, “Texture similarity evaluation using ordinal co-occurrence,” Proc. Intl. Conf. on Image Processing (ICIP), Singapore, October 2004; A. Eleyan and H. Demirel, “Co-occurrence matrix and its statistical features as a new approach for face recognition,” Turk J. Elec. Eng. & Comp. Soi., vol. 19, no. 1, 2011; and D. A. Clausi, “An analysis of co-occurrence texture statistics as a function of grey level quantization,” Can. J. Remote Sensing, vol. 28, no. 1, pp. 45-62, 2002. The studies of co-occurrence aims to label or segment the image into regions, and the co-occurrences are used to generate an augmented attribute representation of the image neighborhood. These attribute representations are then subsequently clustered. However, these techniques do not detect objects. Image segmentation assigns each pixel of the image to a cluster based on an attribute representation, but irrespectively of whether the pixels assigned to the same cluster form a spatial configuration as a whole, i.e., a meaningful shape.

A number of studies have attempted to automatically recognize and identify shapes. Studies that discuss the topic of shape analysis include: I. L. Dryden and K. V. Mardia, “Size and shape analysis of landmark data,” Biometrika, vol. 79, no. 1, pp. 57-68, 1992; A. M. Peter and A. Rangarajan, “Information Geometry for Landmark Shape Analysis: Unifying Shape Representation and Deformation.” IEEE Transactions on Pattern Analysis and Machine Intelligence, vol. 21, no. 2. pp. 337-350, Feb. 2009; G. J. A. Amaral, L. H. Dore, R. P. Lessa, and B. Stosic, “k-means algorithm in statistical shape analysis,” Communications in Statistics—Simulation and Computation, vol. 39, pp. 1016-1026, 2010; and A. Srivastava, S. Joshi, W. Mio, and X. Liu, “Statistical shape analysis: clustering, learning, and testing.” IEEE Transactions on Pattern Analysis and Machine Intelligence, vol. 27, no. 4, pp. 590-602, April 2005. The techniques described in the references above focus on the analysis of shapes that are defined by a discrete set of points, termed landmarks in the literature. The landmarks may include contours, functions defined on the space, such as level sets, or other representations of a shape. However, these approaches assume that the input comprises already of a shape, or some corresponding representation of a spatial configuration or geometry of points, and focus on their analysis.

Accordingly, techniques for automated detection and identification of subsurface features may be useful. Such techniques may increase the efficiency of an interpreter in locating features of interest, such as hydrocarbon reservoirs.

### SUMMARY

An embodiment described herein provides a method for interpreting geophysical data to identify structures in a subsurface. The method includes performing an iterative optimization that includes computing similarities between potential shapes and shape cluster models, updating cluster memberships and the shape cluster models, and determining if a criterion is improved from a previous iteration.

Another embodiment provides a system for analyzing geophysical data. The system includes a processor, and a storage medium. The storage medium includes a representation of a geophysical data set including pixels and attributes corresponding to each of the pixels. The system also includes a non-transitory machine readable medium including code configured to direct the processor to iteratively compute similarities between potential shapes and shape cluster models, update cluster memberships and the shape cluster models, determine if a criterion has improved since a previous iteration, and exit the iteration when a criterion is substantially unchanged between iterations.

Another embodiment provides a method for identifying or characterizing hydrocarbon prospects within a subsurface represented by a seismic data set. The method includes iterating by computing potential shapes from seismic attributes in an image, computing similarities between the potential shapes and shape cluster models, updating cluster memberships and the shape cluster models. A criterion is determined during the iteration, and the iteration is exited if the criterion is substantially unchanged from a previous iteration. The shape cluster models determined during the iteration are presented.

Another embodiment provides a non-transitory, computer-readable storage media for storing computer-readable instructions. The computer-readable instructions include code configured to direct a processor to compute similarities between potential shapes and shape cluster models, update cluster memberships and the shape cluster models, and exit an iteration when a criterion is substantially unchanged from a previous iteration.

An exemplary embodiment provides a method for interpreting geophysical data to identity structures in a subsurface. The method comprising: detecting anomalous data elements by values of geophysical data, aggregating anomalous data elements into high level elements based, at least in part, on co-occurring spatial patterns in the anomalous data elements; and presenting high level elements to an interpreter for confirmation.

Another embodiment provides a system for analyzing seismic data. The system includes a processor; a storage medium comprising: a representation of a seismic data set comprising pixels; and attributes corresponding to each of the pixels; and a non-transitory machine readable medium comprising code configured to direct the processor to: generate initial cluster memberships; generate initial shape cluster models; iteratively: compute similarities between potential shapes and shape cluster models; and update cluster memberships and shape cluster models.

Another embodiment provides a method for identifying or characterizing hydrocarbon prospects within a subsurface represented by a seismic data set. The method comprising: detecting anomalous data elements in the seismic data set; clustering the anomalous data elements to create cluster labeled data elements; aggregating anomalous data elements into geologic features based, at least in part, on co-occurring spatial patterns in the cluster labeled data elements; and presenting the geologic features to an interpreter for confirmation.

Another embodiment provides a non-transitory, computer-readable storage media for storing computer-readable instructions. The computer-readable instructions A non-transitory, computer-readable storage media for storing computer-readable instructions, the computer-readable instructions comprising code configured to direct a processor to: generate initial cluster memberships; generate initial shape cluster models; iteratively: compute similarities between potential shapes and shape cluster models; update cluster memberships and shape cluster models; and exit the iteration when criteria are met.

### DESCRIPTION OF THE DRAWINGS

The advantages of the present techniques are better understood by referring to the following detailed description and the attached drawings, in which:

FIG. 1 is a process flow diagram of a method for detecting geologic features;

FIG. 2 is a schematic overview of the method for detecting geologic features from seismic data;

FIG. 3 is a process flow diagram of a method for clustering pixels to detect geologic features;

FIG. 4 is a process flow diagram of a shape clustering method that uses a spatial pyramid match kernel;

FIG. 5 a process flow diagram of a shape clustering method that is independent of spatial pyramid matching (SPM);

FIG. 6 is a process flow diagram of a shape clustering method using a direct calculation method;

FIG. 7 is a schematic overview of the methods of the present techniques applied to synthetic seismic data in a volume;

FIG. 8 is a process flow diagram also showing a top-down inference method; and

FIG. 9 is a block diagram of a cluster computing system that may be used to implement the techniques described herein for analyzing geophysical data.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Attribute” means the result of a specific mathematical operation performed on at least a portion of the data. For example, seismic data may be processed so that positive amplitudes correspond to strata which have higher impedances than underlying or overlying strata, while negative amplitudes correspond to lower impedance strata. For this example, an event duration attribute may be defined to be the time interval on each trace during which the event's amplitude does not change sign. This attribute is useful because it relates to the thickness of the geologic stratum, although it also depends on the velocity of sound in the stratum and on the bandwidth of the seismic data. Generally attributes are influenced by seismic processing, but their usefulness comes from their dependence on specific properties of the subsurface material. As used herein, attributes may also include other types of geophysical data, such as rock density, rock impedance, porosity, permeability, flow gradients, and the like. Note that the seismic data can also be an attribute (obtained through the identity operation).

An example of an attribute is an AVA attribute. Amplitude-vs.-angle or AVA attributes are quantities calculated from the variation of seismic amplitudes with incident angle of P wave. The AVA attributes include intercept and gradient, and AVA inversion products, such as impedance to P-waves (Ip), impedance to S-waves (Is), density, and/or combinations thereof. Also, it should be noted that the AVA attributes are data volumes of values calculated from AVA parameterization of seismic data, another type of attribute is based on amplitude-vs.-offset or “AVO.” Variations in seismic reflection amplitude with change in distance between shotpoint and receiver that indicate differences in lithology and fluid content in rocks above and below the reflector. AVO analysis is a technique by which geophysicists attempt to determine thickness, porosity, density, velocity, lithology and fluid content of rocks. Successful AVO analysis requires special processing of seismic data and seismic modeling to determine rock properties with a known fluid content. With that knowledge, it is possible to model other types of fluid content. A gas-filled sandstone may show increasing amplitude with offset, whereas a coal may show decreasing amplitude with offset. However, AVO analysis using source-generated or mode-converted shear wave energy provides differentiation of degrees of gas saturation.

“Computer-readable medium” or “non-transitory, computer-readable medium” as used herein refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions.

As used herein, “to display” or “displaying” includes a direct act that causes displaying of a graphical representation of a physical object, as well as any indirect act that facilitates displaying a graphical representation of a physical object. Indirect acts include providing a website through which a user is enabled to affect a display, hyperlinking to such a website, or cooperating or partnering with an entity who performs such direct or indirect acts. Thus, a first party may operate alone or in cooperation with a third party vendor to enable the information to be generated on a display device. The display device may include any device suitable for displaying the reference image, such as without limitation a virtual reality display, a 3-d display, a CRT monitor, a LCD monitor, a plasma device, a flat panel device, or printer. The display device may include a device which has been calibrated through the use of any conventional software intended to be used in evaluating, correcting, and/or improving display results (for example, a color monitor that has been adjusted using monitor calibration software). Rather than (or in addition to) displaying the reference image on a display device, a method, consistent with the invention, may include providing a reference image to a subject. “Providing a reference image” may include creating or distributing the reference image to the subject by physical, telephonic, or electronic delivery, providing access over a network to the reference, or creating or distributing software to the subject configured to run on the subject's workstation or computer including the reference image. In one example, the providing of the reference image could involve enabling the subject to obtain the reference image in hard copy form via a printer. For example, information, software, and/or instructions could be transmitted (for example, electronically or physically via a data storage device or hard copy) and/or otherwise made available (for example, via a network) in order to facilitate the subject using a printer to print a hard copy form of reference image. In such an example, the printer may be a printer which has been calibrated through the use of any conventional software intended to be used in evaluating, correcting, and/or improving printing results (for example, a color printer that has been adjusted using color correction software).

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state. As used herein, “fluid” is a generic term that can encompass either liquids or gases.

The term “gradient” refers to the rate of change of any property, such as pressure, in a given direction.

A “geologic model” is a computer-based representation of a subsurface earth volume, such as a petroleum reservoir or a depositional basin. Geologic models may take on many different forms. Depending on the context, descriptive or static geologic models built for petroleum applications can be in the form of a 3-D array of cells, to which geologic and/or geophysical properties such as lithology, porosity, acoustic impedance, permeability, or water saturation are assigned (such properties are be referred to collectively herein as “reservoir properties”). Many geologic models are constrained by stratigraphic or structural surfaces (for example, flooding surfaces, sequence interfaces, fluid contacts, faults) and boundaries (for example, facies changes). These surfaces and boundaries define regions within the model that possibly have different reservoir properties.

A “hydrocarbon” is an organic compound that primarily includes the elements hydrogen and carbon, although nitrogen, sulfur, oxygen, metals, or any number of other elements may also be present in small amounts. As used herein, hydrocarbons generally refer to organic materials (e.g., natural gas) that are harvested from hydrocarbon containing sub-surface rock layers, termed reservoirs.

The term “interpreter” refers to a person skilled in geologic interpretation. An interpreter is involved in the development of an exploration prospect.

The term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C₁) as a significant component. Raw natural gas also typically contains higher carbon number compounds, such as ethane (C₂), propane, and the like, as well as acid gases (such as carbon dioxide, hydrogen sulfide, carbonyl sulfide, carbon disulfide, and mercaptans), and minor amounts of contaminants such as water, nitrogen, iron sulfide, wax, and crude oil.

As used herein, “seismic attributes” are measurements based on seismic data. Non-limiting examples of seismic attributes include local amplitude, phase, frequency, dip, discontinuity, velocity, or impedance. Such seismic attributes may be used to facilitate manual or automatic recognition of desired geologic features in seismic data. Seismic attributes can be obtained by any one of a variety of well-known transformations applied to seismic data, or simply by measurements made on the seismic traces. In addition, seismic attributes are quantitatively descriptive of some aspect of the wavelike nature of the seismic signals relating to the seismic data.

The term “seismic data” refers to a multi-dimensional matrix or grid containing information about points in the subsurface structure of a field, where the information was obtained using seismic methods. Seismic data typically is represented using a structured grid. Seismic attributes or properties can be represented in individual cells, such as pixels or volume pixels (voxels). Seismic data may be volume rendered with opacity or texture mapped on a surface.

As used herein, “seismic prospecting techniques” are techniques commonly used to aid in the search for and evaluation of subterranean hydrocarbon deposits. Seismic prospecting techniques typically involve three separate stages, namely, data acquisition, data processing, and data interpretation. The subterranean hydrocarbon deposits that are identified using the seismic processing techniques may be referred to as “prospects.”

The term “seismic volume” refers to particular seismic data defined at locations in a three-dimensional representation of seismic data. Thus, data may be represented as a multi-dimensional matrix of values, wherein three coordinates are used to represent the three-dimensional location of a particular data volume in space, such as x, y, and z, and numerous additional terms may be used to represent specific physical attributes associated with the volume, such as amplitude, velocity, density, seismic attributes, and the like.

The term “seismic wave” refers to any mechanically generated wave, such as a pressure wave (p-wave) or a shear wave (s-wave), that propagates in the subsurface of the earth or sea. One of ordinary skill in theart will recognize that seismic data can be augmented with or substituted by other types of data used to characterize the subsurface. Such geophysical, geological, or engineering data include but are not limited to resistivity, density, geological models, or the results of reservoir simulations.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

In digital computing systems, data values for seismic and geologic measurements are represented over a discrete grid representation of the space. This process is known as discretization. An image represents some space on a two-dimensional (2-D) grid of picture elements, known as “pixels.” A volume typically refers to the generalization of this concept to 3-D and higher-dimensional spaces. The term “voxel,” or volume pixel, refers to the smallest data point in a three-dimensional volumetric object. Each voxel has a unique set of coordinates and contains one or more data values that represent the properties at each set of coordinates. Thus, each voxel represents a discrete sampling of a three-dimensional space, similar to the manner in which pixels represent sampling of the two-dimensional space. The location of a voxel can be calculated using the grid origin, the unit vectors, and the indices of the voxel. Since the concepts described herein are fundamentally the same irrespective of the dimensionally of the grid, the description herein may refer to an “image” or “volume” interchangeably and, similarly, may refer to its corresponding grid elements as “pixels” or “voxels.” Thus, any reference to an image or a pixel includes the the representation of a space on a two or higher dimensionally grid space. It can also be noted that, although the grid may be a (structured) lattice of elements sampled with regular spacing, the grid may be unstructured such that elements may be irregularly sampled and have different sizes.

### Data Representation

The discrete grid representation is a convenient mechanism for the representation of “raw” data, but does not describe the contents of the image, e.g., whether adjoining pixels are parts of a single structure. Therefore, the representation does not reflect the presence of shapes or objects which are of interest for analysis or understanding of the image contents. As used herein, a “shape” is a set of spatially inter-related pixels. Generally, the pixels forming the shape may share similar or inter-related attribute representations, such as similar data values, neighborhoods, spatial properties, or statistics derived thereof. As used herein, an “attribute representation” is an array of one or more values derived from the image, and may include the image “intensity” values themselves. The attribute representation is available over the same grid space over which the image has been discretized. Accordingly, an “object” is a shape with an overall meaning associated to it.

### Overview

Given an attribute representation at each pixel in the region of interest of the image, methods and a system to model and cluster those pixels into shapes are provided. The shapes may ultimately correspond to an object of interest, such as a fault, a channel, a dome, a seam, a hydrocarbon bearing rock, or any number of other subsurface features. The method relies on a measure between attribute representations or sets thereof over spatially related neighborhoods, as the means to compare pixels of the image and determine if they should be clustered, or aggregated, together.

During the process, the method may derive a nonparametric model of the clusters, which can be used to characterize each observed shape or object in terms of its form, probabilistic likelihood, or assignment to one or more mean shapes, other shapes, object statistics, and the like. In addition, the model may be used to further generate additional examples of shapes or objects. In this mode, the model is generative of the data. Because the model is nonparametric, it can cluster and model shapes or objects with an arbitrary spatial configuration of pixels. It can be noted that the clustering process is unsupervised, meaning that it learns the groups of shapes and their corresponding models without requiring examples of what the shapes may appear to be like or which pixels can make up a shape.

The methods can be applied in the oil and gas industry for analysis and modeling of geological shapes from geophysical data. In reservoir modeling, for example, multiple shapes may be used to characterize the trend and variability of a given geologic feature, such as a braiding channel or a river delta. Given such data, the disclosed method can cluster and generate concise models of the different shapes. Those models could then be applied to a shape obtained from geophysical data to identify related examples, quantify uncertainty, or analyze potential variations.

Generally speaking, the disclosed techniques identify shapes by detecting sets of spatially related pixels based on their spatial co-occurrences. The present method can be distinguished from other techniques in image segmentation, for which co-occurrences have also been used. The main difference arises from the fact that the present techniques detect and recognize cluster shapes. In the present method, pixels may be assigned to a cluster of shapes when they have a meaningful spatial configuration or geometry as characterized by the specified measure. Thus, the method described herein can be used to precisely identify potential groupings of pixels such that they form a shape, e.g., recognizing what shapes are inherently associated with the image. Because no particular shape is expected to be identified in the image, or is used to guide the process, the method described herein can identify shapes in an unsupervised manner.

In contrast, while previous approaches in image segmentation generally assigned each pixel of the image to a cluster based on an attribute representation, it was irrespectively of whether the pixels assigned to the same cluster formed a spatial configuration as a whole. Even if the previous image segmentation methods were not limited to inputs with defined shapes or characterizations thereof, they often assumed the availability of some form of related information which can guide the shape identification process. In that sense, the previous methods can be described as supervised learning processes. As an example of supervised learning, consider a set of images each containing a mug, a pear, or an apple, in which the goal is to differentiate images with different objects. Prior methods could be used for this task, provided that some images with the corresponding correct classification were provided as examples. The examples are be used to “teach” the method how to classify the images, the shapes, or characterizations thereof.

Such information may be hard to obtain or unavailable for geologic structures. Therefore, the present method is not based on teaching examples that are based on currently known shapes. Hence, with regards to the same example, the present techniques may process the images, or a related characterization, and determine potential shapes using only correspondences between pixels inferred directly from the pixel attribute representations.

As a result, the proposed approach can identify unknown shapes in complex problem settings. For example, an image may have multiple shapes or objects, which need to be recognized and distinguished. This problem is more complex than supervised learning. In addition to the problem of recognizing and relating shapes, it is harder to determine which pixels and clusters of pixels (elements) in the image may be combined to characterize each shape.

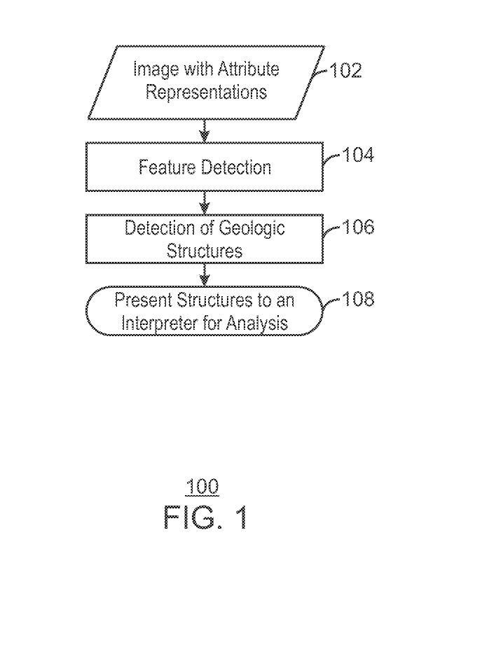

FIG. 1 is a process flow diagram of a method 100 for detecting geologic features. The method 100 starts at block 102 with an image that includes attribute representations. The attribute representations may include acoustic impedance data, for example, collected by seismic surveys, and other seismic data. The attribute representations may also include physical data such as permeability, porosity, flow gradients, rock impedance, rock density, rock composition, and the like.

At block 104, feature detection is performed. In this step, anomalous data elements are detected and may be queued. This assumes that the regions of the seismic image that are considered to be of interest occupy a small part of the entire image. Further, the assumption may be made that most of the image exhibits a small set of repeated patterns. For instance, most of the image can exhibit patterns regarding horizontal geological strata, while a small part of the image may exhibit a geological fault that is captured as a discontinuity in the geological layers. Thus, the image is partitioned into interesting and non-interesting regions. Because interesting regions are assumed to occur sparingly, they can be treated as outliers with regards to the statistical distribution of the patterns of the entire image.

A number of techniques can be used to detect the statistical outliers that indicate regions of interest. These statistical outliers may be used to identify anomalous data elements. For example, principal component analysis (PCA) may be used. In PCA, the distribution of a set of attributes, such as seismic descriptors, is examined. The attributes can be obtained as intensity patches in the given image, or as patches of derived attributes, or as a set of collocated attribute values. Because of the correlation between attributes, the distribution of the vectors of descriptors in the associated high-dimensional space tends be concentrated along a low-dimensional manifold.

PCA provides a computation of a linear approximation to this manifold. Accordingly, the outliers can be detected by computing the Mahalanobis distance to the mean as derived from the Gaussian model derived from PCA. Patches with a large Mahalanobis distance for the descriptor vectors can be labeled as outliers. The outliers may also be detected by choosing a linear subspace spanned by the first few principal components, given by the eigenvectors of the covariance matrix. Each descriptor vector may be projected onto this subspace, and description vectors that are farthest from the subspace can be labeled outliers.

Another technique that can be used to detect the statistical outliers that indicate regions of interest is the statistical analysis of histogram descriptors. In this approach, multi-dimensional histograms are used to estimate the distribution of the seismic descriptors using a coarse binning strategy. Although this approach can only handle a few descriptors at a time, because of the difficulty in estimating the histogram descriptors, it can characterize much wider spatial areas than the PCA-based approach. Thus, the information in the large area is captured into a small number of elements in the histogram.

After capturing the information into the histograms, non-parametric hypothesis testing is performed to determine if a specific histogram is an outlier. This can be done by comparing the distribution of mass in the specific histogram to the mean and standard deviation of the mass distribution over all of the histograms. A large number of attributes may be used as the descriptors for this stage. The selection of these attributes controls the type of features detected. For example, if seismic attributes are considered, patches of orientation vectors (e.g., unit-norm vectors) computed at each voxel can be used instead of seismic intensity values, and this yields results that emphasize changes in dip and azimuth. Such features may include, for example, anticlines, pinchouts, reefs, faults, and other structures that function as hydrocarbon traps.

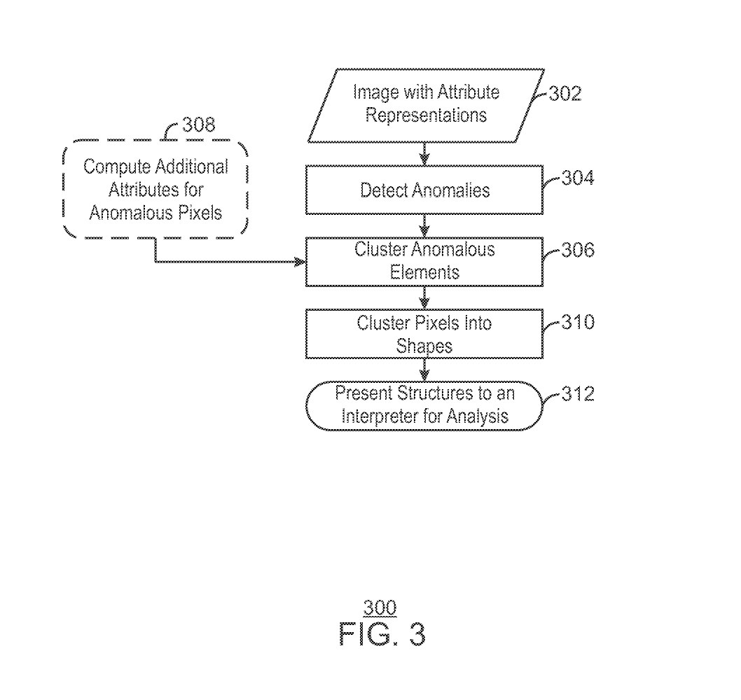

The descriptors may be pre-conditioned to remove certain aspects of the data that are deemed not relevant for a given analysis. For example, the descriptor patches may be reoriented such that, instead of being aligned with the cardinal axes of the image, they are aligned with an orientation estimate at a large-scale. In this example, the approach aligns the patches based on the broad-trend orientation of geological structures at a given location, such as variations of dip or azimuth, thus making the analysis invariant to those variations. This may highlight features that are different from the broad scale trends. The detected features may be inherently encoded, e.g., clustered, during the detection steps. In other embodiments, the encoding may be performed as a separate step, for example, as discussed with respect to FIG. 3.

At block 106, geologic structure detection is performed. This stage can be used to detect recurring configurations of the pixels in an unsupervised manner. By identifying patterns of coded pixels over wide areas of the volume, structures may be recognized, and, thus, potentially interesting objects may be identified. The approach may be based on grouping a collection of coded windows that are scattered all over the seismic volume. In one example, one can employ the technique of spatial pyramid matching (SPM) that relies on a pyramid match kernel to efficiently compute the kernel similarity between spatial pyramid histograms of coded windows. As used herein, a “kernel” is mathematical concept used to denote a similarity measure with well-defined mathematical properties. Subsequently, the kernel similarity is used to design energy functions whose optima are the desired grouping. The output of this stage is a collection of coded windows, each representing a part of a large geological structure, which may correspond, for example, to a fault or a channel, among others.

At block 108, the resulting detected structures or high level elements can can be presented to an interpreter for confirmation. This may take place after the analysis is completed, or the structures may be stored for later analysis. For example, the structures may be superimposed over an initial image to highlight features for an interpreter. This may provide a mechanism for an interpreter to analyze greater volumes of data and to identify features that may otherwise have been undetected.

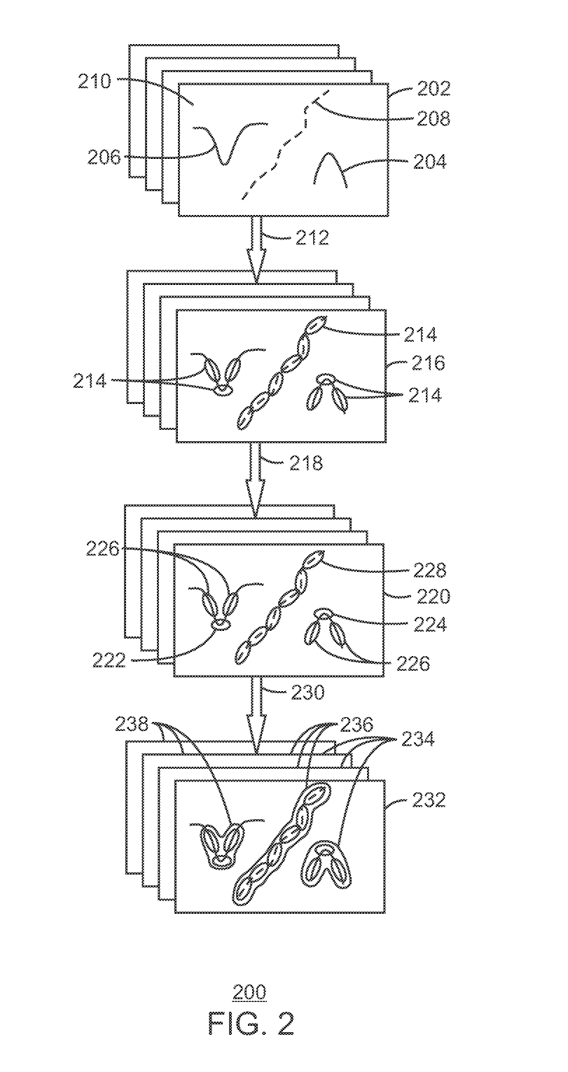

FIG. 2 is a schematic overview 200 of the method for detecting geologic features from seismic data. The initial images 202 can have numerous geologic features, such as anticlines 204, synclines 206, and faults 208, among others. In seismic images, these features can be difficult to distinguish from the background 210, making the analysis time-consuming. Further, an interpreter may miss features, especially after examining a substantial number of images 202.

The images 202 can be processed in a feature detection and queuing step 212 to identify anomalies 214, as described with respect to block 104 of FIG. 1. The anomalies 214, shown in the second set of images 216 are merely labeled pixels that make up anomalous features, and have not been separated into individual types of geologic features. In a feature encoding step 218, the anomalies are clustered together by type of anomaly. For example, as shown in a third set of images 220, pixels 222 at the bottom of an syncline 206 may have a first value for an attribute, while pixels 224 at the top of an anticline 204 may have a second value for the attribute. Similarly, pixels 226 in the sides of the anticline and synclines may have a third value for the attribute, while pixels 228 may have a fourth value for the attribute.

In a geologic structure detection step 230, pixels that belong to unified structures, or shapes, may be identified by co-occurrences, as described with respect to block 106 of FIG. 1. The results are shown in a fourth set of images 232. For example, as the pixels 224 at the top of the anticline 204 are in close proximity to or overlap, e.g., co-occur, with the pixels 226 in the adjacent edges, they can be grouped to identify an anticline pixel shape 234 in the images 232. The pixels 228 that correspond to a fault attribute may be grouped to form a fault shape 236. Similarly, the pixels 222 that correspond to the bottom of the syncline 206 may be grouped with adjacent pixels 226 that form syncline/anticline edges to form a syncline shape 236.

FIG. 3 is a process flow diagram of a method 300 for clustering pixels to detect geologic features. The explicit clustering step for the attribute representations is a pre-processing step specific to further processing using spatial pyramid matching (SPM). At block 302, an image with attribute representations is retrieved, for example, by data collection or from a previously collected data set. At block 304, anomalous pixels in the data are detected, for example, as discussed with respect to block 104 in FIG. 1. At block 306, the anomalous pixels are clustered by attribute representations.

The clustering serves as a discretization step of the local image structure and relies on unsupervised clustering methods. Feature encoding can cluster each set of descriptors associated with an outlier pixel so that sets of descriptors corresponding to similar elements of a geologic feature are assigned the same label, and are clustered together. A number of clustering methods can be used to generate the cluster labeled data elements in this stage. These include known methods, such as, K-means clustering, fuzzy-c-mean clustering, or an expectation maximization algorithm. As a result of this stage, each pixel previously detected as an outlier is assigned to a discrete number of clusters. The assignment of a pixel to a cluster determines its membership. The membership can be discrete, e.g., to a single cluster, or fuzzy, e.g., where the membership to a given cluster is given by a probability between zero and one, such that the assignment probabilities over all possible clusters sum to one.

It may be desirable to compute additional or a different set of attributes, as indicated at block 308, for the clustering process in block 306. For example, seismic reflection values processed through an AVO technique may be calculated for the image to indicate if liquids, such as hydrocarbons, may be present. At block 310, the pixels may be clustered into shapes to detect geologic structures, as described with respect to block 108 of FIG. 1. At block 312, the structures may be presented to an interpreter for analysis, stored for later analysis, or both.

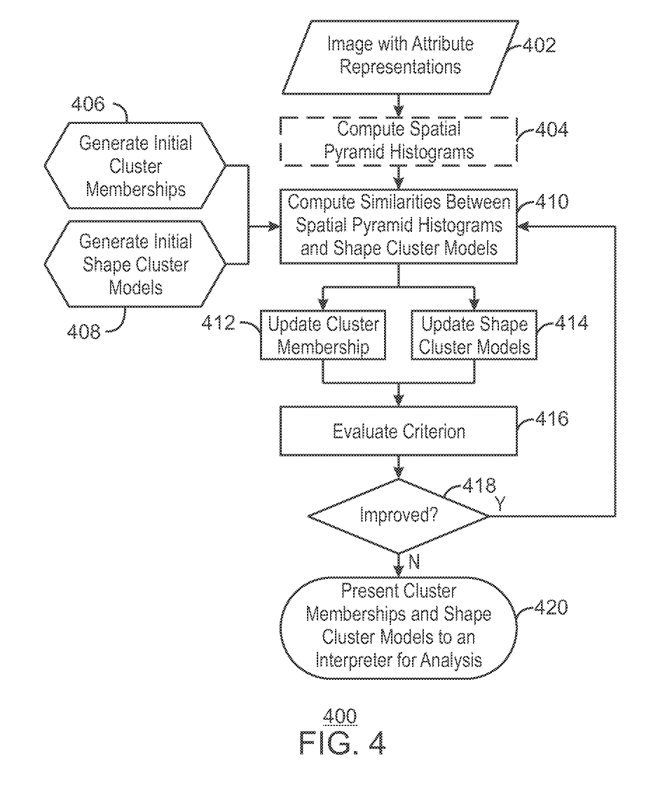

FIG. 4 is a process flow diagram of a shape clustering method 400 that uses a spatial pyramid match (SPM) kernel. The shape clustering method 400 is one technique for aggregating anomalous data elements into high level elements, such as shapes, based, at least in part, on co-occurring spatial patterns in the cluster labeled data elements. The method 400 may be used to implemented block 230 of FIG. 2, and block 310 of FIG. 3, among others. The method begins at block 402 by obtaining an image with attribute representations from a database.

At block 404, spatial pyramid histograms are calculated for the image. Consider a B-bin histogram descriptor H={H(b):b=1, . . . , B}, where H(b) denotes the histogram mass in bin b over a D-dimensional domain. Spatial pyramid histograms are descriptors of co-occurrences and spatial configurations which may be used to characterize general shapes. The histogram descriptor lies within the unit simplex: Ω=(νε [symbol] :Σ_{b=1}^{B}ν(b)=1; ν(b)≧0,∀b). Then, the L-scale histogram pyramid for H is given by (H^{l}:l=1, . . . , L) where H¹≐H and H^{l}=φ^{l}(H¹) is the histogram at level l (l=1 is the finest level; l=L is the coarsest level). The number of histograms bins is B^{l} at level l. At the finest level, B≐B¹≐2^{(L-1)D} and B^{l}≐B/2^{(l-1)D}. The coarsest level has a single bin. The linear operator φ^{l}(•) is selected to perform spatial box averaging, using a 2^{l-1}× . . . ×2^{l-1} D-dimensional mask, followed by subsampling, for example, by a factor of 2^{l-1} along each dimension.

The histogram intersection between histograms H and H at level l can then be defined as shown in equation (1).

I(H₁^{l},H₂^{l})≐Σ_{b=1}^{B}^{^{l}}min(H₁^{l}(b),H₂^{l}(b)) (1)

The histogram intersection can be considered to be a degree of similarity between two histograms, which quantifies the number of matches between the masses in the bins of the histograms. The histogram intersection is a Mercer kernel. The pyramid matching kernel (PMK) similarity between two histogram descriptors H₁ and H₂ can then be determined by equation (2).

S(H₁,H₂)≐w¹I(H₁¹,H₂¹)+Σₗ₌₂^{L}w^{l}[I(H₁^{l},H₂^{l})−I(H₁^{l-1},H₂^{l-1})] (2)

In equation (2), w^{l}≐½^{l-1} is the weight associated with level l. The weights reduce with increasing level coarseness. Note that ∀H₁, H₂εΩ:0<S(H₁, H₂)≦1. The quantity [I(H₁^{l}, H₂^{l})−I(H₁^{l-1}, H₂^{l-1})] is equal to the number of new matches occurring at level l, which did not occur at any of the finer levels. The PMK is also a Mercer kernel. The application of the PMK kernel to a spatial pyramid histogram is called the spatial pyramid match (SPM) kernel, which evaluates similarities between spatial configurations based on spatial co-occurrences of labels, as captured in the spatial pyramid histograms.

At block 406, initial cluster memberships are generated, while at block 408, initial shape cluster models are generated. The initial cluster memberships for each spatial pyramid histogram can be generated by setting the cluster membership to a non-negative random number and normalized such that they sum to one for each input spatial pyramid histogram. The shape cluster models are defined by sets of spatial pyramid histograms. An initialization can be generated, for example, by setting the first level of the spatial pyramid histograms H¹ with non-negative random numbers and deriving the higher levels of the spatial pyramid histograms as H^{l}=φ^{l}(H¹). An alternative initialization may involve setting the spatial pyramid histograms as combinations of one or more randomly selected input histograms, for instance.

At block 410, similarities between spatial pyramid histograms and shape cluster models are computed using equation (4). Consider a set of N spatial-configuration based histogram descriptors (H₁, . . . , H_{N}). The goal is to group these histograms into C clusters, where each cluster c is represented/modeled nonparametrically by R_{c} B-bin histograms {G_{c1}, . . . , G_{cR}_{_{c}}} that capture the geometry and variability of shapes in the cluster. When R_{c}=1, the single class-representative histogram G_{c1} for a class c is analogous to the “mean” for that class.

The similarity between a histogram H, and a class-representative histogram Go., underlying the model for class c can be defined by equation (3).

S_{ncr}=S(Hₙ,G_{cr}) (3)

In equation (3), S(•) is the SPM similarity kernel defined in equation (2). The similarity between a histogram Hₙ and class c can then be defined as shown in equation (4).

$${T}_{nc} \dot{=} \frac{1}{{R}_{c} exp ( β )} {\sum }_{r = 1}^{{R}_{c}} exp ( β {S}_{ncr} ) \qquad ( 4 )$$

In equation (4), βε[0, ∞) is a model parameter, (β=0) [symbol] (T_{nc}=1,∀n,∀c), and 0<1/(R_{c}exp(β))≦T_{nc}≦1.

At block 412, the cluster memberships can be updated, using equation (5).

$${F}_{nc} = \frac{{[ {T}_{nc} ]}^{1 / α}}{{\sum }_{c = 1}^{C} {[ {T}_{nc} ]}^{1 / α}} \qquad ( 5 )$$

Equation (5) is based on Lagrange multipliers, which produce the optimal update for the membership values, given similarities {T_{nc}}. Thus, a larger similarity T_{nc} between histogram Hₙ and class c, increases the membership of Hₙ in class c. It can be noted that (α→∞) [symbol] (F_{nc}→1/C:∀n∀c), i.e., a completely fuzzy clustering. The value of α=0 gives a crisp clustering, i.e., F_{nc}=1 if and only if T_{nc}>T_{nd}:∀d, otherwise F_{nc}=0.

The cluster membership update of equation (5) can perform hard or fuzzy clustering of the shapes. Fuzzy clustering is a form of clustering where the shapes are “partially assigned” to the different clusters, meaning that the cluster membership is a given by a number between 0 and 1 corresponding to the amount by which the shape is assigned to a given cluster. The cluster memberships are required to sum to one over the clusters, as indicated in equation (15). Because of this normalization (summing to one), cluster memberships can be thought of as conditional probabilities of each cluster given a particular shape. Thus, fuzzy cluster membership can be useful in preserving uncertainties in the clustering, which can later be used for analysis. Hard clustering can be thought of as an extreme case of fuzzy clustering in which the shape is assigned to only one cluster at a time, with membership in a cluster equal to one and all other cluster memberships equal to zero. In this algorithm, this is controlled through the a parameter, as discussed with respect to equation (5).

At block 414, the shape cluster models can be updated. The method of projected gradient ascent produces the optimal updates for the cluster-representative histograms {G_{cr}}, given memberships F_{nc}, as shown in equation (6).

$$∀ c , ∀ r \text{:} {G}_{cr} = 𝒫 ( {G}_{cr} + τ \frac{\partial J}{\partial {G}_{cr}} ) \qquad ( 6 )$$

In equation (6), τ is an adaptive step size, and [symbol] : [symbol] [symbol] Ω is a projection operator from the Euclidean space [symbol] to the unit simplex Ω. The projection [symbol] (•) is computed by solving a quadratic-programming problem. This problem can be solved using a linear-complexity algorithm, among others. The derivative of the objective function J (cf. equations (12) and (13)) with respect to a class representative histogram G_{cr} is shown in equation (7).

$$\frac{\partial J}{\partial {G}_{cr}} = {\sum }_{n = 1}^{N} {F}_{nc} {W}_{ncr} β \frac{\partial {S}_{ncr}}{\partial {G}_{cr}} \qquad ( 7 )$$

In equation (7), W_{ncr} can be calculated using equation (8).

$${W}_{ncr} = \frac{exp ( β {S}_{ncr} )}{{\sum }_{r = 1}^{{R}_{c}} exp ( β {S}_{ncr} )} \qquad ( 8 )$$

Thus, histograms Hₙ with larger memberships F_{nc} in a class c contribute more, relative to other histograms, towards the update for G_{cr}. Further, histograms Hₙ with larger similarity S_{ncr} to the representative G_{cr} for class c also contribute more. i.e., a larger W_{ncr}, relative to other histograms, towards the update for G_{cr}. Similar to the class-membership values F_{nc}, the values W_{ncr}, with 0<W_{ncr}≦1 and Σᵣ₌₁^{R}^{_{c}} W_{ncr}=1, can be considered as representative-affinity values. These properties are useful for the stability of solutions for G_{cr}. It can be noted that β=0 leads to a solution where all mixture components have the same optimal values. The derivative of the similarity S_{ncr}, as shown in equation (7), with respect to a class representative histogram G_{cr} is shown in equation (9).

$$\frac{\partial {S}_{ncr}}{\partial {G}_{cr}} = {w}^{1} \frac{\partial }{\partial {G}_{cr}^{1}} I ( {H}_{nc}^{1} , {G}_{cr}^{1} ) + {\sum }_{l = 2}^{L} {w}^{l} [ \frac{\partial }{\partial {G}_{cr}^{1}} I ( {H}_{nc}^{l} , {G}_{cr}^{l} ) - \frac{\partial }{\partial {G}_{cr}^{1}} I ( {H}_{nc}^{l - 1} , {G}_{cr}^{l - 1} ) ] \qquad ( 9 )$$

In equation (9), as noted previously for the histograms, G_{cr}¹≐G_{cr}.

The derivative of the histogram intersection I(H_{nc}^{l}, G_{cr}^{l}) with respect to the value in the b^{th} bin of the histogram G_{cr}¹ is shown inequation (10).

$$\frac{\partial }{\partial {G}_{cr}^{1}} I ( {H}_{nc}^{l} , {G}_{cr}^{l} ) = \frac{\partial }{\partial {G}_{cr}^{1} ( b )} I ( {φ}^{l} ( {H}_{nc}^{1} ) , {φ}^{l} ( {G}_{cr}^{1} ) ) = {\sum }_{a ∈ 𝒜 ( {φ}^{l} )} \frac{\partial }{\partial {G}_{cr}^{l} ( a )} min ( {H}_{nc}^{l} ( a ) , {G}_{cr}^{l} ( a ) ) \qquad ( 10 )$$

In equation (10), [symbol] (φ^{l}) is the set of bins, at level l, whose footprint under the linear operator φ^{l}(•) contains bin b at level 1. The derivative of the min(•) function is shown in equation (11).

$$\frac{\partial }{\partial y} min ( x , y ) = \frac{\partial }{\partial y} 0.5 ( x + y - \vert y - x \vert ) \qquad ( 11 )$$

In equation (11), the discontinuous absolute-value (L₁-norm) function is regularized in dual space using a small regularization parameter that undergoes annealing during iterative optimization. This is an useful component of the proposed method. In has been determine in tests that the entire optimization process, including annealing, converges in about 100 iterations.

In block 416, the criterion is evaluated for the convergence, using an (implicit) definition of the criterion J({F_{nc}}, {G_{cr}}|{Hₙ}). An example criterion is shown in equations (12) and (13). The optimal clustering can be defined as the solution to the constrained optimization problem shown in equations (12) and (13).

$$\begin{matrix}\{ {F}_{nc}^{optimal} \} , \{ {G}_{cr}^{optimal} \} \dot{=} arg {max}_{\{ {F}_{nc} \} , \{ {G}_{cr} \}} J ( \{ {F}_{nc} \} , \{ {G}_{cr} \} \vert \{ {H}_{n} \} ) & ( 12 ) \\ \dot{=} arg {max}_{\{ {F}_{nc} \} , \{ {G}_{cr} \}} {\sum }_{c = 1}^{C} {\sum }_{n = 1}^{N} ( {F}_{nc} log {T}_{nc} - α {F}_{nc} log {F}_{nc} ) & ( 13 )\end{matrix}$$

The constrained optimization problem is subject to the constraints shown in equations (14)-(17).

F_{nc}≧0:∀n,∀c (14)

Σ_{c=1}^{C}F_{nc}=1:∀n (15)

G_{cr}(b)≧0:∀c,∀r,∀b (16)

Σ_{b=1}^{B}G_{cr}(b)=1:∀c,∀r (17)

In equations (14)-(17), αδ[0, ∞) is a user-defined free parameter and F_{nc} is the fuzzy membership for histogram Hₙ in class c.

It can be noted that the negative of the criterion, −J({F_{nc}}, {G_{cr}}|{Hₙ}), is a form of the Kullback-Leibler divergence apart from the parameter a. The Kullback-Leibler divergence is an information theoretic measure between distributions, such as normalized histograms. Many possible measures exist that can be used to compare the distribution of the cluster memberships to the distribution of similarities between spatial pyramidal histograms and cluster models in lieu of the Kullback-Leibler divergence criterion shown in equations (12) and (13). For example, Renyi's family of α-divergences, where the a is not related to the previously discussed a parameter. The Renyi family of α-divergences include the Kullback-Leibler divergence as a special case (when α=1). In the above case, since the algorithm compares histograms, the integration used in the Renyi equations are be replaced with a summation. Another technique that may be used to compare the histograms is the Minkowski family of distances. For example, the standard squared, or Euclidean, distance is a special case for the Minkowski distance of order 2. Using any of the alternative criteria, the optimization follows the same steps albeit with a different gradient, given by equations (7) and (9), to account for the different criterion. Depending on the criterion, the optimization goal may have to be changed from a maximization to a minimization and, therefore, from gradient ascent or to gradient descent, i.e., by changing the plus sign to a minus sign in equation (6).

At block 418, the criteria are tested to determine if there has been improvement. If the improvement is not sufficient, process control resumes at block 410 to repeat the optimization. If sufficient improvement is found, at block 420 the cluster memberships and shape cluster models can be stored for use in other methods. The stored models may be displayed to an interpreter for further analysis.

The operations in blocks 406-418 implement the optimization part of the method. The stopping criterion can be implemented in a number of ways known in the art. For example, the optimization can be stopped if the criterion crosses above or below a pre-defined threshold, depending on whether the goal is maximization or minimization. In another example, the optimization can be stopped if the relative change in the criterion is smaller than a threshold, meaning that the optimization is close to a (local) optimum of the criterion. Further, the optimization can be stopped if the number of iterations reaches a maximum. The stopping criterion can also be a combination of any of these criteria.

It can be noted that the spatial pyramid histograms are computed on clustered or discretized attribute representations. As described herein, the discretization of the attribute representations is combined into the computation of spatial pyramid histograms. This is described in S. Lazebnik, and C. Schmid, and J. Ponce, “Beyond bags of features: Spatial pyramid matching for recognizing natural scene categories,” Proc. IEEE Intl. Conf. on Computer Vision and Pattern Recognition, New York, N.Y., USA, June 2006. The spatial pyramid histograms on the discretized data are then compared through the spatial pyramid match (SPM) kernel similarity measure.

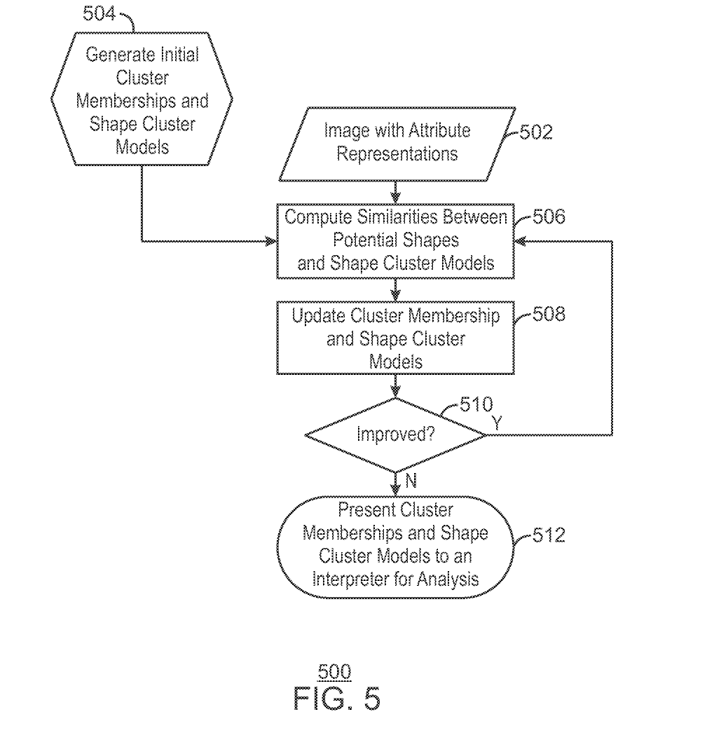

FIG. 5 a process flow diagram of a shape clustering method 500 that is independent of spatial pyramid matching (SPM). The method starts at block 502, by obtaining an image for the analysis. At block 504, the initial cluster memberships and shape models are generated. As described with respect to FIG. 1, this may be done by PCA, or other grouping pixels that have attributes within a predetermined range of other pixels. At block 506, the similarities between potential shapes and shape cluster models could be done by techniques other than SPM. For example, the alternative measures of shapes provided in M. H. Coen, “A similarity metric for spatial probability distributions.” available at http://people.csail.mit.edu/mhcoen/Similarity.pdf could be used. Hence, other shape measures could be used in lieu of the SPM kernel. At block 508, the cluster membership and shape cluster models can be updated. At block 510, fit criteria are tested to determine if the fit meets predetermined criteria. If not, process flow resumes at block 504 to continue iterating. If the fit criteria are met, process flow proceeds to block 512 to store the cluster memberships and shape cluster models.

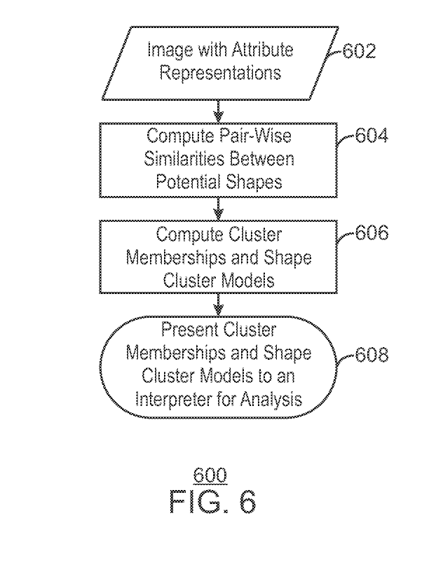

FIG. 6 is a process flow diagram of a shape clustering method using a direct calculation method 600. In some cases, the optimization may be implicitly performed, e.g., by direct solution of the problem. These cases are typically associated with specific problem formulations and allow the optimum optimization result to be obtained mathematically in closed-form. This means that one obtains a formula or procedure that, when applied, yields the optimum result (solution) directly, i.e., without the need for iterations. If iteration is not needed, then a direct calculation of the solution may be made, for example, using the spectral techniques discussed herein, among others. The method 600 begins at block 602 with the retrieval of an image with associated attributes. At block 604, the pair wise similarity between potential shapes is calculated.

At block 606, the cluster memberships and shape cluster models are calculated. Examples of clustering methods which take advantage of implicit optimization are spectral clustering and normalized cuts. Combined with similarity matrices computed with an appropriate shape similarity measure, such as SPM, the direct calculation methods could be used for shape clustering as well. However, in these methods, the model is also only computed implicitly, which may make it more difficult to analyze. At block 608, the cluster memberships and shape cluster models are presented to an interpreter for confirmation and analysis.

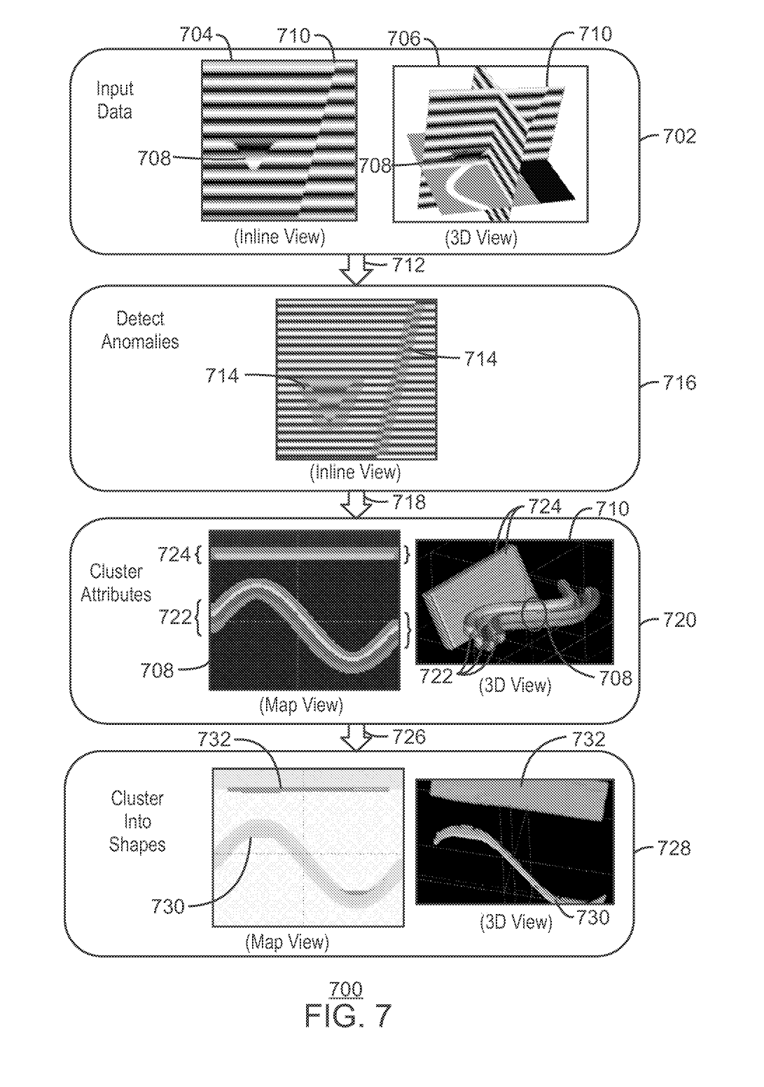

FIG. 7 is a schematic overview 700 of the methods of the present techniques applied to synthetic seismic data in a volume. In the first block 702, shown in an inline view 704 and a three dimensional view 706 of a data volume, illustrates that the generated data has a channel 708 and a fault 710. Although these features may be clear in simulated data, which has little variability outside of the features 708 and 710, the substantial variability in a regular seismic pattern may make the features harder to identify. Further, an interpreter may miss features, especially after examining a substantial number of volumes. The volumes in block 702 can be processed in a feature detection and queuing step 712 to identify anomalies 714, as described with respect to block 304 of FIG. 3 and block 404 of FIG. 4. In this example, the volume in block 716 shows the voxels pertaining to the channel or the fault highlighted by thresholding the Mahalanobis distance computed from intensity patches.

The anomalies 714 shown in the volumes in block 716 are merely collections of voxels that make up anomalous features, and have not been separated into geologic features. In a feature encoding step 718, as described with respect to block 306 of FIG. 3 or blocks 406, 408, an 410 of FIG. 4, the anomalies are clustered together by type of anomaly. For example, as shown in the volumes in block 720, voxels 722 at different levels of the channel 708 may be clustered or labeled as belonging to a group by the techniques discussed with respect to blocks 310 of FIG. 3 or blocks 412 and 414 of FIG. 4. Similarly, voxels 724 that make up the different regions of the fault 710 may be clustered together by the same techniques. In a geologic structure detection step 726, voxels that belong to unified structures, or shapes, may be identified by co-occurrences, as described with respect to block 310 of FIG. 3 and blocks 412, 414, and 416 of FIG. 4. The results are shown in the volumes in block 728. For example, as the voxels 722 that form the channel are proximate or overlap, they can be grouped to identify a channel shape 730 in the volumes, as shown in block 728. Similarly, the voxels 724 that correspond to a fault attribute may be grouped to form a fault shape 732.

The techniques discussed with respect to FIGS. 3 and 4 may be considered a bottom up inference procedure. However, the techniques are not limited to a bottom up inference procedure, as the system can also be exploited for “top-down” exploration of a seismic volume in an unsupervised or supervised manner.

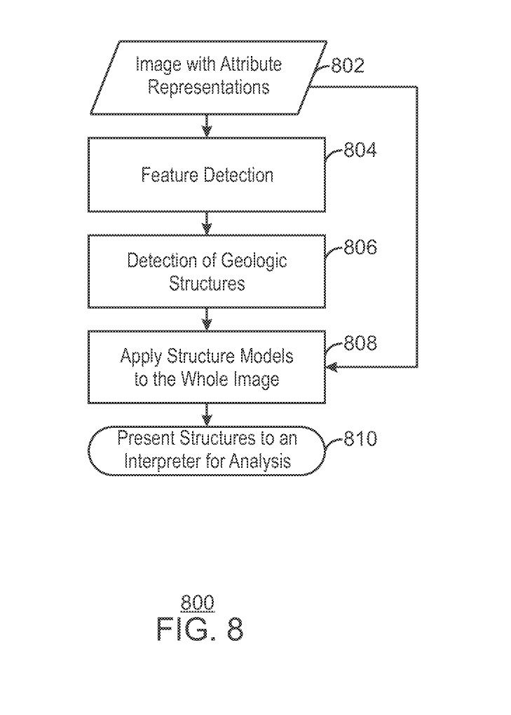

FIG. 8 is a process flow diagram also showing a top-down inference method 800. The basic idea is to trace back the application of the workflow on the whole volume such as to detect voxels that are likely to belong to a structure from context. In the unsupervised form, the result of the top-down inference step may be used to search for similar objects in the seismic volume. The inference process involves applying the structure model identified previously on sets of descriptors for every window in the volume. It can be noted that, in the first pass, the geologic structure detection is only applied to regions detected in the feature detection step. At block 802, an image with the attribute representations is obtained from data collection or a storage system. At block 804, a feature detection is performed, for example, using the techniques described herein. At block 806, geologic structures are detected, for example, using the techniques described herein. In this technique, new structures are not generated, but previously identified structure clustering definitions or models may be applied to the new features detected. The main advantage of this additional process is that voxels that had not been detected as anomalies in the previous feature detection attempts can now be considered and detected if their context suggests that they are part of a geologic structure. At block 808, the structural models are applied to the whole image. The general idea is to derive potential shape characterizations, such as spatial pyramid histograms, for the whole image and calculate the shape similarity measure between those characterizations and the shape cluster models. Shape characterizations similar enough to one of the shape cluster models may be assigned to that cluster. This allows us to detect shapes even if they were not detected in the feature detection. At block 810, the structures identified are presented to an interpreter for analysis.

The supervised form proceeds in a similar fashion, the main difference being that the interpreter provides quality checks of the structures obtained in the bottom-up process and certifies which ones should be used in the top-down process or provides examples of geologic structures of interest, or a database of corresponding definitions, from which the appropriate clustering and grouping definitions to use in the search are to be derived.

The top-down inference process can be applied to a volume different from the one from which the structure models were identified. This allows models obtained in one volume to be applied in another for a more directed search. In most cases, the application of models determined in one volume to another may verified by a user, but this is not required. The top-down part of the method proceeds as described, in either the unsupervised or supervised form, the difference being that the sets of descriptors for the inference process are derived from the target volume to which the process is being applied.

The top-down inference can be used to provide example data to train the feature detection stage. As described earlier, the feature detection stage is unsupervised in the sense that no examples of the desired result are given. Instead, the methods in that stage rely exclusively in the statistics of the data and the assumption that features of interest are anomalous. After the top-down inference process, however, the voxels detected as features can be used as examples to train feature detection methods. This is particularly useful if the structures identified or the results of the top-down inference process have been verified by a user.

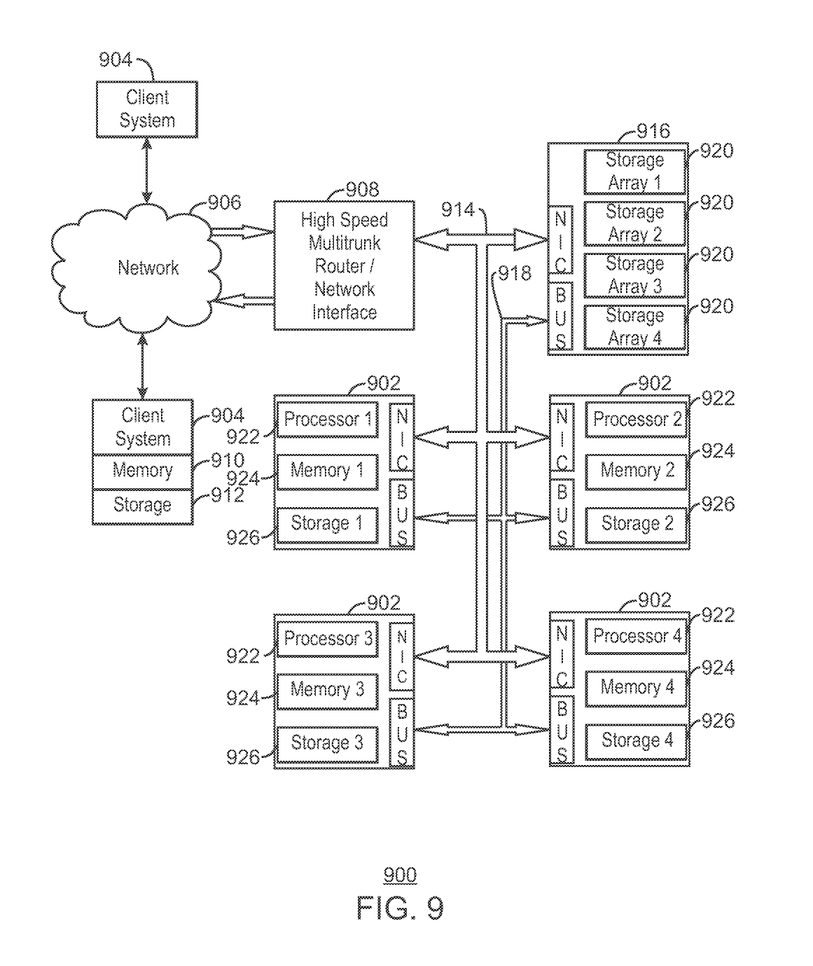

FIG. 9 is a block diagram of a cluster computing system 900 that may be used to implement the techniques described herein for analyzing geophysical data. The cluster computing system 900 illustrated has four computing units 902, each of which may perform calculations for analyzing seismic data. However, one of ordinary skill in the art will recognize that the present techniques are not limited to this configuration, as any number of computing configurations may be selected. For example, a smaller model may be run on a single computing unit 902, such as a workstation, while a large model may be run on a cluster computing system 900 having 10, 100, 1000, or even more computing units 902.

The cluster computing system 900 may be accessed from one or more interpreter systems 904 over a network 906, for example, through a high speed network interface 908. The network 906 may include a local area network (LAN), a wide area network (WAN), the Internet, or any combinations thereof. Each of the interpreter systems 904 may have non-transitory, computer-readable memory 910 for the storage of operating code and programs, including random access memory (RAM) and read only memory (ROM). The operating code and programs may include the code used to implement all or any portions of the methods discussed herein, for example, as discussed with respect to FIGS. 1 through 8. Further, the non-transitory computer-readable media may hold images with attribute representations, shapes, geologic structures, checkpoints, and results, such as a data representation of a subsurface space. The interpreter systems 904 can also have other non-transitory, computer-readable media, such as storage systems 912. The storage systems 912 may include one or more hard drives, one or more optical drives, one or more flash drives, any combinations of these units, or any other suitable storage device. The storage systems 912 may be used for the storage of images, checkpoints, code, models, data, and other information used for implementing the methods described herein.

The high-speed network interface 908 may be coupled to one or more communications busses in the cluster computing system 900, such as a communications bus 914. The communication bus 914 may be used to communicate instructions and data from the high-speed network interface 908 to a cluster storage system 916 and to each of the computing units 902 in the cluster computing system 900. The communications bus 914 may also be used for communications among computing units 902 and the storage array 916. In addition to the communications bus 914, a high-speed bus 918 can be present to increase the communications rate between the computing units 902 and/or the cluster storage system 916.

The cluster storage system 916 can have one or more non-transitory, computer-readable media devices, such as storage arrays 920 for the storage of checkpoints, data, visual representations, results, code, or other information, for example, concerning the implementation of and results from the methods of FIGS. 1 through 9. The storage arrays 920 may include any combinations of hard drives, optical drives, flash drives, holographic storage arrays, or any other suitable devices.

Each of the computing units 902 can have a processor 922 and an associated local tangible, computer-readable media, such as memory 924 and storage 926. Each of the processors 922 may be a multiple core unit, such as a multiple core CPU or a GPU. The memory 924 may include ROM and/or RAM used to store code, for example, used to direct the processor 922 to implement the methods described below with respect to FIGS. 1 through 9. The storage 926 may include one or more hard drives, one or more optical drives, one or more flash drives, or any combinations thereof. The storage 926 may be used to provide storage for checkpoints, intermediate results, data, images, or code associated with operations, including code used to implement the methods described below with respect to FIGS. 1 through 9.

The present techniques are not limited to the architecture or unit configuration illustrated in FIG. 9. For example, any suitable processor-based device may be utilized for implementing all or a portion of embodiments of the present techniques, including without limitation personal computers, networks personal computers, laptop computers, computer workstations, GPUs, mobile devices, and multi-processor servers or workstations with (or without) shared memory. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments described herein.

### Embodiments

Embodiments of the invention may include any combinations of the methods and systems shown in the following numbered paragraphs. This is not to be considered a complete listing of all possible embodiments, as any number of variations can be envisioned from the description above.

1. A method for interpreting geophysical data to identify structures in a subsurface, including performing an iterative optimization including:

computing similarities between potential shapes and shape cluster models;

updating cluster memberships and the shape cluster models; and

determining if a criterion is improved from a previous iteration.

2. The method of paragraph 1, including computing spatial pyramid histograms from attributes in an image.

3. The method of paragraphs 1 or 2, including exiting the iterative optimization if the criterion has not substantially changed between iterations.

4. The method of paragraph 1, 2, or 3, including presenting the shape cluster models to an interpreter.

5. The method of any of paragraphs 2 to 4, wherein computing spatial pyramid histograms includes calculating a plurality of histogram descriptors (Hₙ) from attributes of an image, wherein each H, is each at a different scale level 1, forming an L-scale histogram pyramid (H¹).

6. The method of any of paragraphs 2 to 5, wherein computing similarities includes calculating a similarity (S_{ncr}) between a histogram descriptor (Hₙ) and a shape cluster model (G_{cr}) in a plurality of shape cluster models (G_{cr}^{l}).

7. The method of any of paragraphs 2 to 6, wherein updating cluster memberships includes:
calculating a class similarity (T_{nc}) between a histogram descriptor (Hₙ) and a model for a class (c); and
updating a cluster membership (F_{nc}) for the Hₙ.

8. The method of any of paragraphs 2 to 7, wherein updating the shape cluster models includes updating each G_{cr} based, at least in part, on the cluster memberships.

9. The method of any of the preceding paragraphs, wherein iterating includes solving a constrained optimization problem as shown in the following equations:

$$\begin{matrix}\{ {F}_{nc}^{optimal} \} , \{ {G}_{cr}^{optimal} \} \dot{=} arg {max}_{\{ {F}_{nc} \} , \{ {G}_{cr} \}} J ( \{ {F}_{nc} \} , \{ {G}_{cr} \} \vert \{ {H}_{n} \} ) \\ \dot{=} arg {max}_{\{ {F}_{nc} \} , \{ {G}_{cr} \}} {\sum }_{c = 1}^{C} {\sum }_{n = 1}^{N} ( {F}_{nc} log {T}_{nc} - α {F}_{nc} log {F}_{nc} ) .\end{matrix}$$

10. The method of paragraph 9, including subjecting the constrained optimization problem to the criteria in the following equations:

F_{nc}≧0:∀n,∀c;

Σ_{c=1}^{C}F_{nc}=1:∀n;

G_{cr}(b)≧0:∀c,∀r,•b; and

Σ_{b=1}^{B}G_{cr}(b)=1:∀c,∀r.

11. The method of paragraph 9, including using the negative value of the criterion −J({F_{nc}}, {G_{cr}}|{Hₙ}) in a Kullback-Leibler divergence.

12. The method of paragraph 9, including using a Renyi α-divergence to compare the distributions of cluster memberships and similarities.

13. The method of any of paragraphs 2 to 12, including using a Minkowski distance to compare the distributions of cluster memberships and similarities.

14. The method of any of paragraphs 2 to 13, wherein presenting the shape cluster models includes displaying the shape cluster models over the image.

15. The method of paragraph 9, including annealing a regularization parameter during the iterative optimization.

16. The method of any of the preceding paragraphs, including calculating updated cluster memberships such that they optimize a criterion.

17. The method of paragraph 16, including calculating conditional probabilities for cluster memberships.

18. The method of any of the preceding paragraphs, including calculating pixel membership in a shape by a top-down inference.

19. A system for analyzing geophysical data, including:
a processor,
a storage medium including:
   a representation of a geophysical data set including pixels; and
   attributes corresponding to each of the pixels; and
a non-transitory machine readable medium including code configured to direct the processor to iteratively:
   compute similarities between potential shapes and shape cluster models;
   update cluster memberships and the shape cluster models;
   determine if a criterion has improved since a previous iteration; and
   exit the iteration when the criterion is substantially unchanged between iterations.

20. The system of paragraph 19, wherein the non-transitory machine readable medium includes code configured to direct the processor to compute spatial pyramid histograms from attributes in an image.

21. The system of paragraphs 19 or 20, wherein the non-transitory machine readable medium includes code configured to direct the processor to:

generate initial cluster memberships; and

generate initial shape cluster models.

22. The system of paragraphs 19, 20, or 21, wherein the non-transitory machine readable medium includes code configured to direct the processor to display geologic features that are detected.

23. The system of any of paragraphs 20 to 22, wherein the non-transitory machine readable medium includes code configured to direct the processor to compute similarities between spatial pyramid histograms and shape cluster models.

24. The system of any of paragraphs 20 to 23, wherein the non-transitory machine readable medium includes code configured to direct the processor to overlap the display of geologic features detected with an initial image.

25. The system of any of paragraphs 20 to 24, wherein the attributes include seismic intensities, p-wave intensity values, s-wave intensity values, migrated seismic intensity values, or any combinations thereof.

26. The system of any of paragraphs 20 to 25, wherein the attributes include reflectivity values, rock density values, porosity, or permeability, or any combinations thereof.

27. The system of any of paragraphs 20 to 26, wherein the attributes include liquid flow gradients, thermal gradients, or a combination thereof.

28. A method for identifying or characterizing hydrocarbon prospects within a subsurface represented by a seismic data set, including:

iterating:
computing potential shapes from seismic attributes in an image;
computing similarities between the potential shapes and shape cluster models;
updating cluster memberships and the shape cluster models;
determining a criterion;
exiting the iteration when the criterion is substantially unchanged from a previous iteration; and

presenting the shape cluster models to an interpreter.

29. The method of paragraph 28, including overlapping the shape cluster models on an initial seismic data set to highlight a location for features identified by the shape cluster models.

30. The method of paragraphs 28 or 29, including computing spatial pyramid histograms from seismic data.

31. The method of paragraph 28, 29, or 30, including computing spatial pyramid histograms from other geophysical data.

32. A non-transitory, computer-readable storage media for storing computer-readable instructions, the computer-readable instructions including code configured to direct a processor to:
compute similarities between potential shapes and shape cluster models;
update cluster memberships and the shape cluster models; and
exit an iteration when a criterion is substantially unchanged from a previous iteration.

33. The non-transitory, computer-readable storage media of paragraph 32, including code configured to direct the processor to display the shape cluster models.

34. The non-transitory, computer-readable storage media of paragraphs 32 or 33, including code configured to direct the processor to overlap the display of the shape cluster models detected with an initial image.

35. A method for interpreting geophysical data to identify structures in a subsurface, comprising:
detecting anomalous data elements by values of geophysical data;
aggregating anomalous data elements into high level elements based, at least in part, on co-occurring spatial patterns in the anomalous data elements; and
presenting high level elements to an interpreter for confirmation.

36. The method of paragraph 35, comprising clustering the anomalous data elements to create cluster labeled data elements identifying cluster memberships.

37. The method of paragraph 35, comprising detecting anomalous elements by performing principal component analysis (PCA) of the geophysical data.

38. The method of paragraph 35, comprising detecting anomalous elements by computing the Mahalanobis distance to the mean as obtained from a covariance matrix obtained from the geophysical data.

39. The method of paragraph 35, comprising detecting anomalous elements by:
choosing a linear subspace spanned by a first few principal components, given by the eigenvectors of a covariance matrix;
projecting a plurality of descriptor vectors into the linear subspace; and
labeling a portion of the description vectors that are farthest from the subspace as outliers.

40. The method of paragraph 35, comprising detecting anomalous elements by:
creating multi-dimensional histograms that estimate the distribution of attributes; and
comparing a distribution of mass in a specific multi-dimensional histogram to a mean and a standard deviation of a mass distribution over all of the multi-dimensional histograms.

41. The method of paragraph 35, comprising clustering anomalous data by K-means clustering, fuzzy-c-mean clustering, or an expectation maximization algorithm, or any combinations thereof.

42. The method of paragraph 36, comprising calculating additional attributes for a pixel prior to the clustering operation is performed.

43. The method of paragraph 35, comprising aggregating anomalous data elements by a spatial pyramid match clustering technique.

44. The method of paragraph 36, comprising calculating spatial pyramid histograms for attributes associated with pixels in an image.

45. The method of paragraph 44, comprising calculating a spatial pyramid matching (SPM) similarity between two histogram descriptors.

46. The method of paragraph 44, comprising calculating similarities between spatial pyramid histograms and shape cluster models.

47. The method of paragraph 46, comprising calculating updated cluster memberships such that they optimize a criterion.

48. The method of paragraph 47, comprising calculating conditional probabilities for cluster memberships.

49. The method of paragraph 44, comprising performing a comparison of the distribution of the cluster memberships to the distribution of similarities between spatial pyramidal histograms and cluster models using a Renyi α-divergence.

50. The method of paragraph 44, comprising performing a comparison of the distribution of the cluster memberships to the distribution of similarities between spatial pyramidal histograms and cluster models using a Minkowski distance.

51. The method of paragraph 35, comprising calculating voxel membership in a shape by a top-down inference.

52. A system for analyzing seismic data, comprising:
a processor,
a storage medium comprising:
   a representation of a seismic data set comprising pixels; and
   attributes corresponding to each of the pixels; and
a non-transitory machine readable medium comprising code configured to direct the processor to:
   generate initial cluster memberships;
   generate initial shape cluster models;
   iteratively:
      compute similarities between potential shapes and shape cluster models; and
      update cluster memberships and shape cluster models.

53. The system of paragraph 52, wherein the non-transitory machine readable medium comprises code configured to direct the processor to display geologic features that are detected.

54. The system of paragraph 52, wherein the non-transitory machine readable medium comprises code configured to direct the processor to compute spatial pyramid histograms.

55. The system of paragraph 52, wherein the non-transitory machine readable medium comprises code configured to direct the processor to compute similarities between spatial pyramid histograms and shape cluster models.

56. The system of paragraph 52, wherein the non-transitory machine readable medium comprises code configured to direct the processor to overlap the display of geologic features detected with an initial image.

57. The system of paragraph 52, wherein the attributes comprise seismic intensities, p-wave intensity values, s-wave intensity values, migrated seismic intensity values, or any combinations thereof.

58. The system of paragraph 52, wherein the attributes comprise reflectivity values, rock density values, porosity, or permeability, or any combinations thereof.

59. The system of paragraph 52, wherein the attributes comprise liquid flow gradients, thermal gradients, or a combination thereof.

60. A method for identifying or characterizing hydrocarbon prospects within a subsurface represented by a seismic data set, comprising:
detecting anomalous data elements in the seismic data set;
clustering the anomalous data elements to create cluster labeled data elements;
aggregating anomalous data elements into geologic features based, at least in part, on co-occurring spatial patterns in the cluster labeled data elements; and
presenting the geologic features to an interpreter for confirmation.

61. The method of paragraph 60, comprising overlapping the geologic features on an initial seismic data set to highlight a location for the geologic features.

62. The method of paragraph 60, comprising correlating the anomalous data elements in the seismic data set with other geophysical data.

63. A non-transitory, computer-readable storage media for storing computer-readable instructions, the computer-readable instructions comprising code configured to direct a processor to:

generate initial cluster memberships;

generate initial shape cluster models;

iteratively:
compute similarities between potential shapes and shape cluster models;
update cluster memberships and shape cluster models; and
exit the iteration when criteria are met.

64. The non-transitory, computer-readable storage media of paragraph 63, comprising code configured to direct the processor to display geologic features that are detected.

65. The non-transitory, computer-readable storage media of paragraph 63, comprising code configured to direct the processor to compute spatial pyramid histograms.

66. The non-transitory, computer-readable storage media of paragraph 63, comprising code configured to direct the processor to compute similarities between spatial pyramid histograms and shape cluster models.

67. The non-transitory, computer-readable storage media of paragraph 63, comprising code configured to direct the processor to overlap the display of geologic features detected with an initial image.

68. The non-transitory, computer-readable storage media of paragraph 63, comprising code configured to analyze a volume to form images of cross sections of the volume that highlight geologic features.

While the present techniques may be susceptible to various modifications and alternative forms, the embodiments discussed above have been shown only by way of example. However, it should again be understood that the techniques are not intended to be limited to the particular embodiments disclosed herein. Indeed, the present techniques include all alternatives, modifications, and equivalents falling within the true spirit and scope of the appended claims.

1-34. (canceled)

35. A method for interpreting geophysical data to identify structures in a subsurface, comprising:
detecting anomalous data elements by values of geophysical data;
aggregating anomalous data elements into high level elements based, at least in part, on co-occurring spatial patterns in the anomalous data elements; and
presenting high level elements to an interpreter for confirmation.

36. The method of claim 35, comprising clustering the anomalous data elements to create cluster labeled data elements identifying cluster memberships.

37. The method of claim 35, comprising detecting anomalous elements by performing principal component analysis (PCA) of the geophysical data.

38. The method of claim 35, comprising detecting anomalous elements by computing the Mahalanobis distance to the mean as obtained from a covariance matrix obtained from the geophysical data.

39. The method of claim 35, comprising detecting anomalous elements by:
choosing a linear subspace spanned by a first few principal components, given by the eigenvectors of a covariance matrix;
projecting a plurality of descriptor vectors into the linear subspace; and
labeling a portion of the description vectors that are farthest from the subspace as outliers.

40. The method of claim 35, comprising detecting anomalous elements by:
creating multi-dimensional histograms that estimate the distribution of attributes; and
comparing a distribution of mass in a specific multi-dimensional histogram to a mean and a standard deviation of a mass distribution over all of the multi-dimensional histograms.

41. The method of claim 35, comprising clustering anomalous data by K-means clustering, fuzzy-c-mean clustering, or an expectation maximization algorithm, or any combinations thereof.

42. The method of claim 36, comprising calculating additional attributes for a pixel prior to the clustering operation is performed.

43. The method of claim 35, comprising aggregating anomalous data elements by a spatial pyramid match clustering technique.

44. The method of claim 36, comprising calculating spatial pyramid histograms for attributes associated with pixels in an image.

45. The method of claim 44, comprising calculating a spatial pyramid matching (SPM) similarity between two histogram descriptors.

46. The method of claim 44, comprising calculating similarities between spatial pyramid histograms and shape cluster models.

47. The method of claim 46, comprising calculating updated cluster memberships such that they optimize a criterion.

48. The method of claim 47, comprising calculating conditional probabilities for cluster memberships.

49. The method of claim 44, comprising performing a comparison of the distribution of the cluster memberships to the distribution of similarities between spatial pyramidal histograms and cluster models using a Renyi α-divergence.

50. The method of claim 44, comprising performing a comparison of the distribution of the cluster memberships to the distribution of similarities between spatial pyramidal histograms and cluster models using a Minkowski distance.

51. The method of claim 35, comprising calculating voxel membership in a shape by a top-down inference.

52-59. (canceled)

60. A method for identifying or characterizing hydrocarbon prospects within a subsurface represented by a seismic data set, comprising:
detecting anomalous data elements in the seismic data set;
clustering the anomalous data elements to create cluster labeled data elements;
aggregating anomalous data elements into geologic features based, at least in part, on co-occurring spatial patterns in the cluster labeled data elements; and
presenting the geologic features to an interpreter for confirmation.

61. The method of claim 60, comprising overlapping the geologic features on an initial seismic data set to highlight a location for the geologic features.

62. The method of claim 60, comprising correlating the anomalous data elements in the seismic data set with other geophysical data.

63-68. (canceled)
